(19) United States
(12) Patent Application Publication
(10) Pub. No.: US 2019/0047301 A1
(43) Pub. Date: Feb. 14, 2019

(54) PRINTING APPARATUS

(71) Applicant: SEIKO EPSON CORPORATION, Tokyo (JP)

(72) Inventors: Jun FUJIMAKI, Matsumoto-shi (JP); Takayuki TAMAKI, Shiojiri-shi (JP)

(21) Appl. No.: 16/058,165

(22) Filed: Aug. 8, 2018

(30) Foreign Application Priority Data
Aug. 9, 2017 (JP) 2017-154504

(51) Int. Cl. B41J 11/70; B41J 11/00

(52) U.S. Cl. CPC B41J 11/70; B41J 11/0045

(57) ABSTRACT

A printing apparatus includes a medium supporting section configured to support a medium transported in a first direction on a transport path, a printing section configured to print by impinging liquid onto the medium, a medium guiding section configured to guide the medium downstream by changing, at a location downstream of the medium supporting section on the transport path, a direction along which the medium is transported from the first direction to a second direction intersecting with the first direction, a medium feeding section configured to feed the medium downstream by changing, at a location downstream of the medium guiding section on the transport path, the direction along which the medium is transported from the second direction to a third direction intersecting with the second direction at a position downstream of the medium guiding section on the transport path, and a medium cutting section configured to cut the medium.

The present application is based on and claims priority from JP Application Serial Number 2017-154504, filed Aug. 9, 2017, the disclosure of which is hereby incorporated by reference herein in its entirety.

### BACKGROUND

The disclosure relates to printing apparatuses configured to cut and discharge printed media.

Printing apparatuses are known including a printing section that sticks liquid for printing onto a medium to print images, a medium cutting section that cuts the printed medium to predetermined sizes, and a transporting section that transports the medium along a transport path passing through the printing section and the medium cutting section. The printing section, the medium cutting section, and the transporting section are disposed in a housing, and the medium that has been cut by the medium cutting section is transported downstream of the medium cutting section to be discharged from a paper exit formed in a part of the housing to the outside of the housing (see, for example, JP-A-2014-24283).

### SUMMARY

In a case where liquid for printing adheres to the medium is paper and the like mainly composed of wood fiber and the like and having absorbency, the liquid soaks into the medium, and causes the fibers to be swollen. The swollen fibers push each other, and move from the original positions. This may impair the planarity of the medium. That is, the medium may expand and distort at areas to which liquid adheres due to the fibers pushing each other, and may become wrinkled in the width direction intersecting with the transport direction of the medium. A phenomenon called cockling may occur. The medium wrinkled due to the cockling may not be easily cut, as the planarity of the medium may be impaired.

The disclosure provides a printing apparatus configured to recover the planarity of a medium wrinkled due to so-called cockling caused by adhesion of liquid for printing to a certain extent to readily cut the medium.

A printing apparatus according to the disclosure and advantages of the printing apparatus will be described below.

A printing apparatus according to one aspect of the disclosure includes a medium supporting section configured to support a medium transported in a first direction on a transport path along which the medium is transported, a printing section configured to print by impinging liquid onto the medium supported by the medium supporting section, a medium guiding section configured to guide the medium downstream by changing, at a location downstream of the medium supporting section on the transport path, a direction along which the medium is transported from the first direction to a second direction intersecting with the first direction, a medium feeding section configured to feed the medium downstream by changing, at a location downstream of the medium guiding section on the transport path, the direction along which the medium is transported from the second direction to a third direction intersecting with the second direction, and a medium cutting section configured to cut the medium between the medium guiding section and the medium feeding section on the transport path.

In a case where the medium has absorbency, so-called cockling occurs in the printed medium transported downstream of the medium supporting section on the transport path, and the medium is wrinkled in a width direction intersecting with a transport direction of the medium. Thus, such a wrinkled medium is difficult to cut using the medium cutting section downstream of the medium supporting section due to the impaired planarity.

In this respect, according to the above-described configuration, the printed medium S wrinkled due to cockling is bent such that the transport direction changes from the first direction during printing to the second direction and then to the third direction to remove the ripples at that moment. After the medium is bent such that the transport direction changes from the second direction to the third direction to recover the planarity, the printed medium is cut by the medium cutting section. Thus, the medium wrinkled due to so-called cockling caused by the adhesion of the liquid for printing is readily cut after the planarity is recovered to a certain extent.

In a printing apparatus according to another embodiment, an angle facing downstream along the transport path, and formed by and intersection of a second straight line extending in the second direction with and a first straight line extending in the first direction and an angle facing downstream along the transport path, and formed by an intersection of a third straight line extending in the third direction and the first straight line are different in positive angle and negative angle from each other with respect to the first straight line.

This configuration reduces a space in a direction intersecting with the first direction compared with a case where the direction of the angle formed by the second straight line extending in the second direction with the intersection of the first straight line extending in the first direction toward downstream along the transport path and the direction of the angle formed by the third straight line extending in the third direction with the intersection of the first straight line toward downstream along the transport path are identical to each other.

In a printing apparatus according to another embodiment, the medium guiding section includes a first roller pair and a second roller pair, the first roller pair and the second roller pair being configured to transport the medium downstream along the transport path by rotating while holding the medium.

According to this configuration, when the transport direction of the medium changes from the first direction to the second direction, the medium is held between the roller pair. This enables the medium to be transported downstream along the transport path while the posture of the medium is kept stable.

In a printing apparatus according to another embodiment, the first roller pair is located downstream of the medium supporting section on the transport path, the second roller pair is located downstream of the first roller pair on the transport path, and a distance, in a direction perpendicular to both a width direction of the medium and the first direction, between a second hold position at which the medium is held by the second roller pair and a support position at which the medium is supported by the medium supporting section is larger than a distance, in the direction perpendicular to both the width direction of the medium and the first direction, between a first hold position at which the medium is held by the first roller pair and the support position in a direction perpendicular to both a width direction of the medium and the first direction.

According to this configuration, while the printed medium is guided by the medium guiding section, the transport direction changes from the first direction to the second direction. At this moment, the part of the medium located upstream of the medium guiding section in the transport direction is pressed against the medium supporting section. This enables the medium onto which the printing section prints to be stably supported on the medium supporting section, and thus enables an excellent print quality on the medium to be maintained.

In a printing apparatus according to another embodiment, the medium feeding section includes a third roller pair configured to transport the medium downstream along the transport path by rotating while holding the medium, and a distance, in the direction perpendicular to both the width direction of the medium and the first direction, between a third hold position at which the medium is held by the third roller pair and the second hold position is larger than a distance, in the direction perpendicular to both the width direction of the medium and the first direction, between the first hold position and the second hold position.

According to this configuration, the medium wrinkled due to cockling is bent between the medium guiding section and the medium feeding section to remove the ripples. This enables the medium from which the ripples are removed to be readily cut by the medium cutting section.

In a printing apparatus according to another embodiment, the medium cutting section cut the medium while moving in the width direction intersecting with the direction along which the medium is transported.

According to this configuration, the medium from which the ripples are removed in the width direction by being bent between the medium guiding section and the medium feeding section is readily cut in the width direction.

### BRIEF DESCRIPTION OF THE DRAWINGS

Embodiments of the disclosure will be described with reference to the accompanying drawings, wherein like numbers reference like elements.

FIG. 1 is a side view schematically illustrating an inner structure of a printing apparatus according to one exemplary embodiment.

FIG. 2 is a schematic view illustrating positional relationships among a medium supporting section, a medium guiding section, and a medium feeding section.

FIG. 3 is a front view of the medium supporting section supporting a wrinkled printed medium.

FIG. 4 is a front view of the medium guiding section supporting the printed medium from which the ripples are removed.

### DESCRIPTION OF EXEMPLARY EMBODIMENTS

One exemplary embodiment of a printing apparatus is described below while referencing the accompanying drawings.

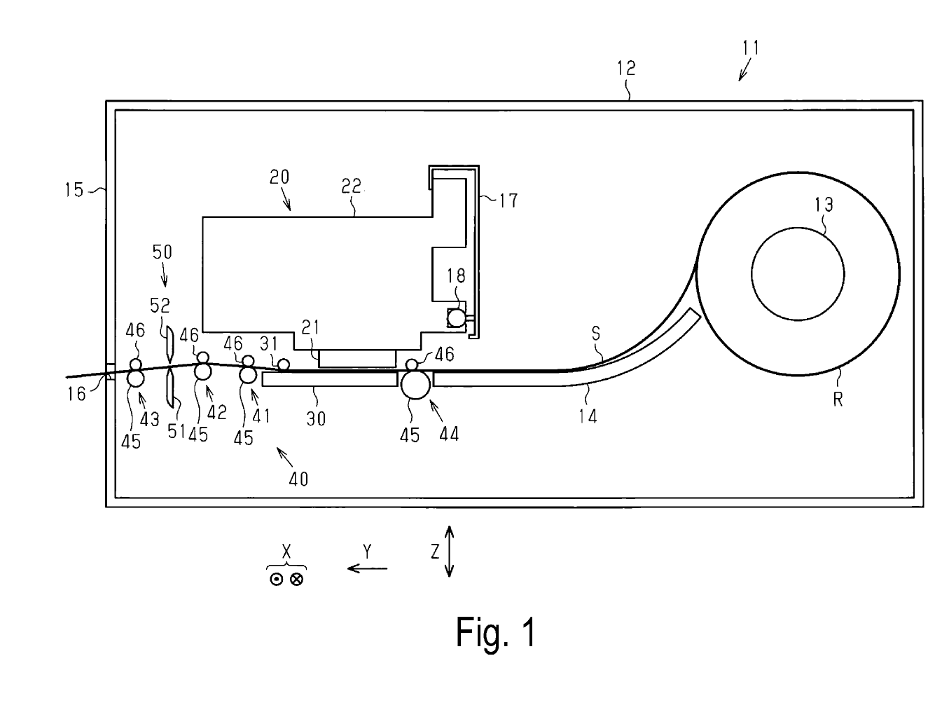

As illustrated in FIG. 1, a printing apparatus 11 includes a rectangular parallelepiped housing 12. The housing 12 accommodates a printing section 20 and a medium supporting section 30. The printing section 20 prints images including letters and pictures on a medium S by impinging liquid such as ink onto the medium S. The medium supporting section 30 supports the medium S on which the printing section 20 prints. The housing 12 also accommodates a transporting section 40 and a medium cutting section 50. The transporting section 40 transports the medium S along a transport path passing through the printing section 20 and the medium supporting section 30. The medium cutting section 50 cuts the printed medium S that is transported by the transporting section 40.

Furthermore, a roll body R is disposed in the housing 12. The roll body R is formed by rolling the medium S, such as paper mainly composed of wood fiber and having absorbency, into the shape of a tube roll. The roll body R is disposed in the housing 12 on the rear side, which is on the right in FIG. 1. The roll body R is rotatably supported by a shaft 13 extending in a width direction X intersecting with a transport direction Y of the medium S. In one exemplary embodiment, the shaft 13 rotates counterclockwise in FIG. 1 to unroll the medium S from the roll body R.

The medium S unrolled from the roll body R is guided toward the printing section 20 by a path-forming member 14. An upstream part of the path-forming member 14 along the transfer path is curved, while a downstream part extends in the horizontal direction along the transport path. The medium S passing through a gap between the printing section 20 and the medium supporting section 30 is transported downstream by the transporting section 40, and discharged from the inside of the housing 12 to the outside of the housing 12 through a discharging port 16 open in a front face 15 of the housing 12. That is, in one exemplary embodiment, the direction from the rear end to the front end of the housing 12, that is the right-to-left direction in FIG. 1, corresponds to the transport direction Y along which the medium S is transported by the transporting section 40. The front face 15 of the housing 12 is a face expanding in a vertical direction Z and in the width direction X.

The printing section 20 includes a head 21 for ejecting, for example, liquid such as ink toward the medium S, and a carriage 22 in which the head 21 is installed. The carriage 22 is supported by a frame 17 disposed in the housing 12 and a guide shaft 18 attached to the frame 17. The guide shaft 18 extends in the width direction X of the medium S. The carriage 22 is supported to be movable with respect to the guide shaft 18 in the width direction X. The carriage 22 moves along the guide shaft 18 to enable the head 21 to eject liquid for printing toward the medium S over the entire area in the width direction X.

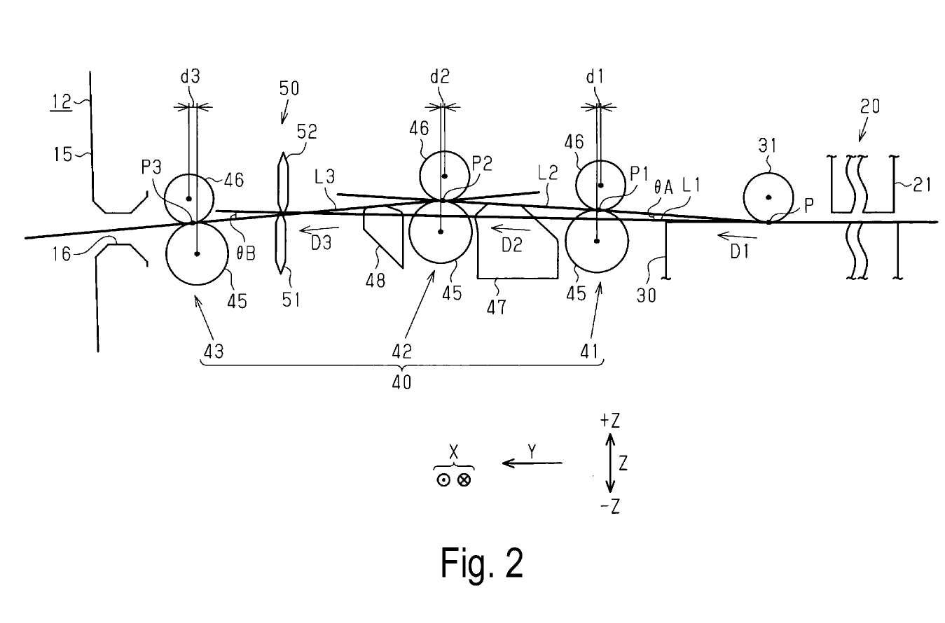

The medium supporting section 30 faces the printing section 20 in the vertical direction Z perpendicular to the width direction X and the transport direction Y of the medium S. A face of the medium supporting section 30 facing the printing section 20 and supporting the medium S extends in a first direction D1 (see FIG. 2) corresponding to the horizontal direction. Thus, the medium S supported by the medium supporting section 30 is subjected to printing and transported downstream on the transport path in the first direction D1. This means that the medium S is transported to the horizontal direction.

Pressure rollers 31 are disposed to be rotatable at positions downstream of the head 21 of the printing section 20 on the transport path above the medium supporting section 30. When the medium S that has been printed by the printing section 20 is transported downstream on the transport path while being supported by the medium supporting section 30, the pressure rollers 31 come into contact with a face of the medium S to which liquid for printing adheres. Each of the pressure rollers 31 is thus composed of a star wheel and the like having a small contact area with the medium S to reduce deterioration of the quality of images printed on the medium S.

The transporting section 40 transports the medium S that has been unrolled from the roll body R from the inside of the housing 12 to the discharging port 16 along the transport path passing through a gap between the printing section 20 and the medium supporting section 30 and through the medium cutting section 50. The transporting section 40 includes roller pairs downstream and upstream of the medium supporting section 30 on the transport path. On downstream of the medium supporting section 30, the transporting section 40 includes a plurality of roller pairs, that is, first roller pairs 41, second roller pairs 42, and third roller pairs 43 from upstream to downstream along the transport path. The transporting section 40 further includes roller pairs 44 on the upstream of the medium supporting section 30.

The downstream roller pairs 41, 42, and 43 and the upstream roller pairs 44 each include a driving roller 45 to be rotatable by a motor (not illustrated) and a driven roller 46 to be rotatable by following the rotation of the driving roller 45. The first roller pairs 41, the second roller pairs 42, the third roller pairs 43, and the upstream roller pairs 44 transport the medium S by rotating while holding the medium S between the driving rollers 45 and the driven rollers 46 to transport the medium S. The driving rollers 45 are disposed to come in contact with the medium S from below, and the driven rollers 46 are disposed to come in contact with the medium S from above.

While transporting the medium S, the driven rollers 46 of the first roller pairs 41, the second roller pairs 42, and the third roller pairs 43 come into contact with the face, to which liquid for printing adheres, of the printed medium S. Thus, each of the driven rollers 46 of the first roller pairs 41, the second roller pairs 42, and the third roller pairs 43 is composed of a star wheel or the like having a small contact area with the medium S, as are the pressure rollers 31 disposed above the medium supporting section 30. The pressure rollers 31, the downstream roller pairs 41, 42, and 43, and the upstream roller pairs 44 are respectively disposed at predetermined intervals in the width direction X.

The medium cutting section 50 is disposed between the second roller pairs 42 and the third roller pairs 43 in the transport direction Y. The medium cutting section 50 includes a disk-shaped driving blade 51 for rotating about a shaft extending in the first direction D1 corresponding to the horizontal direction, and a disk-shaped driven blade 52 similarly rotating about a shaft extending in the first direction D1 by following the rotation of the driving blade 51. The driving blade 51 and the driven blade 52 are located such that the driving blade 51 is located below the driven blade 52 in the vertical direction Z, and the edge of the driving blade 51 at an upper part and the edge of the driven blade 52 at a lower part overlap with each other.

Thus, the medium S is cut between the second roller pairs 42 and the third roller pairs 43 when the driving blade 51 and the driven blade 52 move in the width direction X intersecting with the transport direction Y of the medium S. The medium S is cut by the medium cutting section 50 and is transported downstream by the third roller pairs 43 to be discharged from the discharging port 16. In the printing apparatus 11 according to an exemplary embodiment, the opening of the discharging port 16 in the vertical direction Z is relatively small to avoid users from inserting their fingers from the outside of the housing 12 into the back of the housing 12 (at least to the positions of movable parts such as the medium cutting section 50) through the discharging port 16.

Next, the first roller pairs 41, the second roller pairs 42, and the third roller pairs 43 disposed on the transport path of the medium S downstream of the medium supporting section 30 will be described in detail.

As illustrated in FIG. 2, in the first roller pairs 41, the shaft centers of the driving rollers 45 are located downstream of the shaft centers of the driven rollers 46 by a distance d1 in the transport direction Y. Similarly, in the second roller pairs 42, the shaft centers of the driving rollers 45 are located downstream of the shaft centers of the driven rollers 46 by a distance d2 in the transport direction Y. The positional relationship between the first roller pairs 41 and the second roller pairs 42 is set such that the distance, in the vertical direction Z, between a second hold position P2 at which the medium S is held by the second roller pairs 42 and a support position P at which the medium S is supported by the medium supporting section 30 is larger than the distance in the vertical direction Z between a first hold position P1 at which the medium S is held by the first roller pairs 41 and the support position P.

Thus, when the medium S is transported downstream on the transport path while being held between the first roller pairs 41 and the second roller pairs 42, the transport direction changes from the first direction D1 corresponding to the horizontal direction to a second direction D2 corresponding to a diagonally upward downstream direction intersecting with the first direction D1. In one exemplary embodiment, a medium guiding section configured to guide the medium S downstream by changing, at a location downstream of the medium supporting section 30 on the transport path, the transport direction of the medium S from the first direction D1 to the second direction D2 intersecting with the first direction D1, is configured by the first roller pairs 41 and the second roller pairs 42.

On the other hand, as illustrated in FIG. 2, in the third roller pairs 43, the shaft centers of the driving rollers 45 are located on the upstream side of the shaft centers of the driven rollers 46 by a distance d3 in the transport direction Y. The positional relationships among the first roller pairs 41, the second roller pairs 42, and the third roller pairs 43 are set such that the distance in the vertical direction Z between a third hold position P3 at which the medium S is held by the third roller pairs 43 and the second hold position P2 at which the medium S is held by second roller pairs 42 is larger than the distance in the vertical direction Z between the first hold position P1 at which the medium S is held by the first roller pairs 41 and the second hold position P2.

Thus, when the medium S is transported downstream on the transport path while being held between the second roller pairs 42 and the third roller pairs 43, the transport direction changes from the second direction D2 corresponding to a diagonally upward downstream direction to a third direction D3 corresponding to a diagonally downward downstream direction intersecting with the second direction D2. In an exemplary embodiment, a medium feeding section configured to feed the medium S downstream by changing, at a location downstream of the medium guiding section, the transport direction of the medium S from the second direction D2 to the third direction D3 intersecting with the second direction D2 is configured by the third roller pairs 43.

As illustrated in FIG. 2, a supporting member 47 is disposed between the first roller pairs 41 and the second roller pairs 42. The supporting member 47 comes into contact with the medium S from below, that is, from the −Z direction, to support the medium S transported in the second direction D2 corresponding to the diagonally upward downstream direction while the medium S is held between the first roller pairs 41 and the second roller pairs 42. The face of the supporting member 47 for supporting the medium S extends in the second direction D2 corresponding to the diagonally upward downstream direction. This stabilizes the posture of the medium S transported in the second direction D2 while the medium S is held between the first roller pairs 41 and the second roller pairs 42 constituting the medium guiding section.

Moreover, as illustrated in FIG. 2, a supporting member 48 is disposed between the second roller pairs 42 and the third roller pairs 43 upstream of the medium cutting section 50. The supporting member 48 comes into contact with the medium S from below, that is, from the −Z direction, to support the medium S transported in the third direction D3 corresponding to the diagonally downward downstream direction while the medium S is held between the second roller pairs 42 and the third roller pairs 43. The face of the supporting member 48 supporting the medium S extends in the third direction D3 corresponding to the diagonally downward downstream direction. This stabilizes the posture of the medium S transported in the third direction D3 while the medium S is held between the second roller pairs 42 and the third roller pairs 43 constituting the medium feeding section.

As illustrated in FIG. 2, a first straight line L1 extending in the first direction D1 corresponding to the horizontal direction intersects with a second straight line L2 extending in the second direction D2 corresponding to the diagonally upward downstream direction at the support position P at which the pressure rollers 31 also come into contact with the medium S from above, on the top surface of the medium supporting section 30. In addition, the second straight line L2 extending in the second direction D2 corresponding to the diagonally upward downstream direction intersects with a third straight line L3 extending in the third direction D3 corresponding to the diagonally downward downstream direction at the second hold position P2 at which the medium S is held by the second roller pairs 42.

In this case, an angle 8A, which is an acute angle, facing downstream along the transport path, and formed by the intersection of the second straight line L2 and the first straight line L1 faces the +Z direction side with respect to the horizontal direction, the +Z direction serving as a positive direction in the vertical direction Z. On the other hand, an angle 8B, which is an acute angle, facing downstream along the transport path, formed by the intersection of the third straight line L3 and the first straight line L1 faces the −Z direction side with respect to the horizontal direction, the −Z direction serving as a negative direction in the vertical direction Z. That is, the angle 8A facing downstream along the transport path, formed by the intersection of the second straight line L2 and the first straight line L1 and the angle 8B facing downstream along the transport path, formed by the intersection of the third straight line L3 and the first straight line L1 are different in positive angle and negative angle from each other with respect to the first straight line L1. Thus, when viewed in the width direction X, the direction of the transport path of the medium S in the vertical direction Z changes alternately in the +Z direction and in the −Z direction in a part of the path from the medium supporting section 30 to the discharging port 16 in the housing 12.

Since the direction along which the medium S is transported changes depending on the positional relationship between the shaft centers of the driving rollers 45 and the shaft centers of the driven rollers 46 in the transport direction Y, the positions of the shaft centers of the driving rollers 45, the positions of the shaft centers of the driven rollers 46 in the transport direction Y, the distance d1, the distance d2, and the distance d3 are changed as appropriate depending on the inclinations of the transport path with respect to the horizontal direction.

Next, operations of the printing apparatus 11 configured as above will be described in terms of the state in which the printed medium S is transported downstream on the transport path.

First, the medium S is unrolled from the roll body R, and transported downstream on the transport path. Then, liquid for printing is ejected from the head 21 of the printing section 20 to the medium S while the medium S passes over the medium supporting section 30. The ejected liquid is impinged on the surface of the medium S, and soaks into the medium S due to the absorbency of the medium S. The liquid soaking into the medium S causes the wood fiber and the like serving as the main component of the medium S to be swollen, and the swollen fibers push each other, resulting in expansion and distortion of the areas to which the liquid adheres.

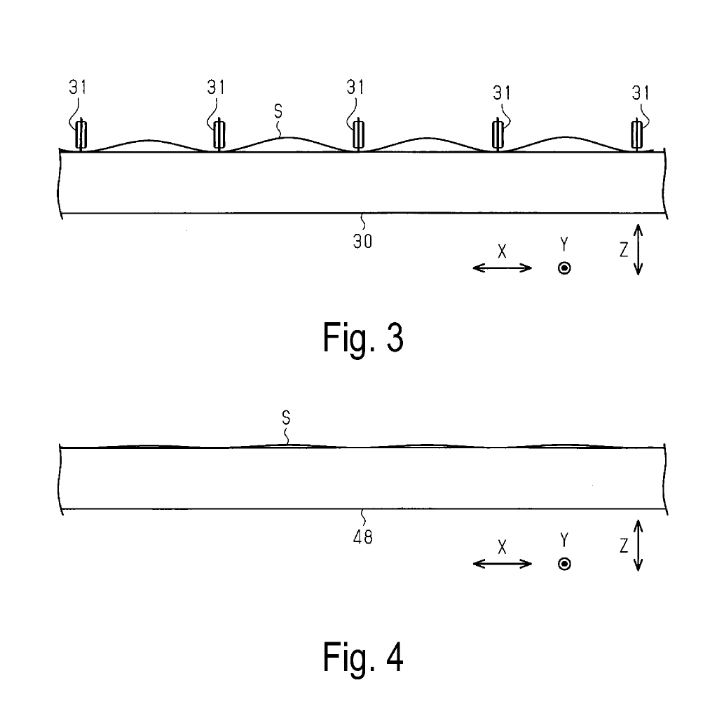

This phenomenon, illustrated in FIG. 3, is so-called cockling in which ripples, that is, projections and depressions in the vertical direction Z, alternately occur in the medium S in the width direction X intersecting with the transport direction Y of the medium S. The medium S wrinkled due to cockling has a higher rigidity in the vertical direction Z, which is also the thickness direction of the medium S, according to the projections and depressions, and thus may be more difficult to cut using the medium cutting section 50. Moreover, the wrinkled medium S has a lower planarity, and the medium S left unchanged may collide against the edge of the discharging port 16 with a relatively small opening in the vertical direction Z. However, in an exemplary embodiment, the ripples in the printed medium S are removed while the medium S is transported downstream on the transport path toward the discharging port 16 as described below.

That is, when the medium S passes through the support position P at which the medium S is held between the pressure rollers 31 and the medium supporting section 30 while being transported, the medium S is bent such that the transport direction changes from the first direction D1 corresponding to the horizontal direction to the second direction D2 corresponding to the diagonally upward downstream direction. Furthermore, when the medium S passes through the second hold position P2 at which the medium S is held between the second roller pairs 42, the medium S is bent such that the transport direction changes from the second direction D2 corresponding to the diagonally upward downstream direction to the third direction D3 corresponding to the diagonally downward downstream direction.

As illustrated in FIG. 4, the multiple times bending (in this case, twice) removes the noticeable ripples in the medium S to a certain extent. That is, the medium S regains the planarity from the state where the medium S is wrinkled with noticeable projections and depressions. It is conceivable that a larger number of times bending, that is, twice more than once, or three times more than twice, is more effective in removing the ripples. As a result, the medium S without the noticeable ripples and with the recovered planarity as illustrated in FIG. 4 approaches the position of the medium cutting section 50. Since the noticeable ripples in the printed medium S before bending are mostly removed and the planarity of the medium S is recovered after bending, the medium cutting section 50 moves in the width direction X, and readily cuts the medium S from which the ripples are removed. Moreover, the medium S with the recovered planarity passes through the discharging port 16 of which opening in the vertical direction Z is relatively small without interfering with the edge of the port, and is discharged from inside the housing 12 to outside the housing 12.

Moreover, while the first roller pairs 41 and the second roller pairs 42 constituting the medium guiding section rotate to transport the medium S downstream on the transport path, the medium S is held between the pairs of the driving rollers 45 and the driven rollers 46. This stabilizes the posture of the medium S. Furthermore, with regard to the positional relationship between the first roller pairs 41 and the second roller pairs 42 constituting the medium guiding section, the first hold position P1 at which the medium S is held by the upstream first roller pairs 41 is located below the second hold position P2 at which the medium S is held by the downstream second roller pairs 42 in the vertical direction Z, that is, in the −Z direction. Thus, a part of the medium S located upstream of the medium guiding section in the transport direction, that is, a part onto which the printing section 20 prints while the medium S is supported by the medium supporting section 30, is pressed against the medium supporting section 30. This enables the medium S to be stably supported during printing.

According to the above-described exemplary embodiments, the following advantages can be obtained.

The printed medium S wrinkled due to cockling is bent such that the transport direction changes from the first direction D1, which is the transport direction during printing, to the second direction D2 and then to the third direction D3 to remove the ripples at that moment. After the medium S is bent such that the transport direction changes from the second direction D2 to the third direction D3 to recover the planarity, the printed medium S is cut by the medium cutting section 50. Thus, the medium S wrinkled due to so-called cockling caused by the adhesion of the liquid for printing is readily cut after the planarity is recovered to a certain extent.

The angle θA facing downstream along the transport path, and formed by the intersection of the second straight line L2 extending in the second direction D2 and the first straight line L1 extending in the first direction D1 and the angle θB facing downstream along the transport path, and formed by the intersection of the third straight line L3 extending in the third direction D3 and the intersection of the first straight line L1 and toward downstream along the transport path are different in positive and negative angle from each other with respect to the first straight line L1. This reduces a space in the vertical direction Z intersecting with the first direction D1 compared with a case where the direction of the angle θA and the direction of the angle θB are identical with respect to the first straight line L1.

When the transport direction of the medium S changes from the first direction D1 to the second direction D2, the medium S is held between the first roller pairs 41 and the second roller pairs 42. This enables the medium S to be transported downstream along the transport path while the posture of the medium S is kept stable.

While the printed medium S is guided by the medium guiding section including the first roller pairs 41 and the second roller pairs 42, the transport direction changes from the first direction D1 to the second direction D2. At this moment, a part of the medium S located upstream of the medium guiding section in the transport direction is pressed against the medium supporting section 30. This enables the medium S, onto which the printing section 20 prints, to be stably supported on the medium supporting section 30, and thus enables an appropriate print quality on the medium S to be maintained.

The medium S wrinkled due to cockling is bent between the medium guiding section including the second roller pairs 42 and the medium feeding section including the third roller pairs 43 to remove the ripples. This enables the medium S from which the ripples are removed to be readily cut by the medium cutting section 50.

The medium S is bent between the medium guiding section including the second roller pairs 42 and the medium feeding section including the third roller pairs 43, and thus the medium S from which the ripples are removed is readily cut by the medium cutting section 50 traveling in the width direction X.

The exemplary embodiments described above may be modified as follows. The configurations included in the above-described exemplary embodiments and the configurations included in the following modified examples may be optionally combined. In addition, configurations included in the following modified examples may be optionally combined.

The medium cutting section 50 may not cut the medium S by moving in the width direction X. For example, the medium cutting section 50 may include a blade body extending in the width direction X, and the blade body may move in the vertical direction Z intersecting with the transport direction Y to cut the medium S.

The distance between the third hold position P3 of the third roller pairs 43 and the second hold position P2 of the second roller pairs 42 in the vertical direction Z may be smaller or equal to the distance between the first hold position P1 of the first roller pairs 41 and the second hold position P2. In short, the third hold position P3 of the third roller pairs 43 may be located at any position below the second hold position P2 of the second roller pairs 42 in the vertical direction Z, that is, in the −Z direction. Therefore, the wrinkled medium S can be bent.

The distance between the second hold position P2 of the second roller pairs 42 and the support position P at which the medium is supported by the medium supporting section 30 in the vertical direction Z may be smaller or equal to the distance between the first hold position P1 of the first roller pairs 41 and the support position P. In short, the hold second position P2 of the second roller pairs 42 may be located at any position as long as the first hold position P1 of the first roller pairs 41 is located above the support position P at which the medium S is supported by the medium supporting section 30 in the vertical direction Z, that is, in the +Z direction. Therefore, the wrinkled medium S can be bent.

The first hold position P1 of the first roller pairs 41 in the vertical direction Z may be identical to the support position P at which the medium S is supported between the pressure rollers 31 and the medium supporting section 30 disposed upstream the second roller pairs 42, or may be located below the support position P, that is, in the −Z direction, as long as the second hold position P2 of the second roller pairs 42 located downstream is on an upper side of the first hold position P1, that is, in the +Z direction.

The first hold position P1 of the first roller pairs 41 and the second hold position P2 of the second roller pairs 42 may not be on the second straight line L2 extending in the second direction D2. For example, the second hold position P2 of the second roller pairs 42 in the vertical direction Z may be located further above the second straight line L2 in the vertical direction Z, that is, in the +Z direction. In this case, the number of times the medium S is bent is increased to remove the ripples of the wrinkled medium S.

Either the first roller pairs 41 or the second roller pairs 42 constituting the medium guiding section may be omitted. In this case, after one of the first roller pairs 41 or the second roller pairs 42 are omitted, the remaining roller pairs and the pressure rollers 31 located upstream may constitute the medium guiding section, or the remaining roller pairs and the adjacent supporting member 47 may constitute the medium guiding section.

The supporting member 47 between the first roller pairs 41 and the second roller pairs 42 may be omitted.

None of the first roller pairs 41 nor the second roller pairs 42 may be included in the medium guiding section, and the medium guiding section may include the supporting member 47. In this case, a face of the supporting member 47 coming into contact with the medium S to support the medium S from below, that is, from the −Z direction, may extend in the second direction D2, and a corner portion of the face located the most downstream and coming into contact with the medium S may be at the uppermost position in the vertical direction Z.

The third roller pairs 43 and the supporting member 48 located upstream of the medium cutting section 50 may constitute the medium feeding section. In this case, a face of the supporting member 48 coming into contact with the medium S to support the medium S from below, that is, from the −Z direction, may extend in the third direction D3, and a corner portion of the face located the most upstream and coming into contact with the medium S may be at the uppermost position in the vertical direction Z and farther than the third hold position P3 of the third roller pairs 43 in the +Z direction.

The medium feeding section may not include the third roller pairs 43, and may include only the supporting member 48. In this case, the face of the supporting member 48 coming into contact with the medium S to support the medium S from below, that is, from the −Z direction, may extend in the third direction D3, and a corner portion of the face located the most upstream and coming into contact with the medium S may be at the uppermost position in the vertical direction Z.

Both the direction of the angle θA facing downstream along the transport path, and formed by the intersection of the second straight line L2 extending in the second direction D2 and the first straight line L1 extending in the first direction D1 and the direction of the angle θB facing downstream along the transport path, and formed by the intersection of the third straight line L3 extending in the third direction D3 and the first straight line L1 may be identical in positive angle and negative angle to each other, with respect to the first straight line L1. In short, any configurations in which the transport directions change at a partway while the wrinkled medium S is transported enables the medium S to be bent to remove the ripples.

The medium S bent such that the transport direction changes from the second direction D2 to the third direction D3 may be bent such that the transport direction changes to a fourth direction intersecting with the third direction D3 to further remove the ripples.

The second direction D2 may be a diagonally downward downstream direction with respect to the first direction D1 corresponding to the horizontal direction, and the third direction D3 may be a diagonally upward downstream direction.

A face of the supporting member 48 supporting the medium S may be located on an upper side of the second hold position P2 at which the medium S is held by the second roller pairs 42 in the vertical direction Z. In this case, the location where the transport path of the medium S changes the direction from upward to downward is located at the supporting member 48 or between the third hold position P3 at which the medium S is held by the third roller pairs 43 and the supporting member 48. This enables the medium cutting section 50 to cut the medium S with reduced ripples at a position closer to the location where the transport path of the medium S changes the direction from upward to downward.

The printing apparatus 11 may not be a serial printing apparatus including the head 21 installed in the carriage 22 configured to reciprocate, but may be a printing apparatus of so-called line head type including a head 21 fixed and extending over the entire width of the transport region of the medium S.

What is claimed is:

1. A printing apparatus comprising:
a medium supporting section configured to support a medium transported in a first direction on a transport path along which the medium is transported;
a printing section configured to print by impinging liquid onto the medium supported by the medium supporting section;
a medium guiding section configured to guide the medium downstream by changing, at a location downstream of the medium supporting section on the transport path, a direction along which the medium is transported from the first direction to a second direction intersecting with the first direction;
a medium feeding section configured to feed the medium downstream by changing, at a location downstream of the medium guiding section on the transport path, the direction along which the medium is transported from the second direction to a third direction intersecting with the second direction; and
a medium cutting section configured to cut the medium between the medium guiding section and the medium feeding section on the transport path.

2. The printing apparatus according to claim 1, wherein
an angle facing downstream along the transport path, and formed by an intersection of a second straight line extending in the second direction and a first straight line extending in the first direction and an angle facing downstream along the transport path, and formed by an intersection of a third straight line extending in the third direction and the first straight line are different in positive angle and negative angle from each other with respect to the first straight line.

3. The printing apparatus according to claim 1, wherein
the medium guiding section includes a first roller pair and a second roller pair, the first roller pair and a second roller pair being configured to transport the medium downstream along the transport path by rotating while holding the medium.

4. The printing apparatus according to claim 3, wherein
the first roller pair is located downstream of the medium supporting section on the transport path,
the second roller pair is located downstream of the first roller pair on the transport path, and
a distance, in a direction perpendicular to both a width direction of the medium and the first direction, between a second hold position at which the medium is held by the second roller pair and a support position at which the medium is supported by the medium supporting section is larger than a distance, in the direction perpendicular to both the width direction of the medium and the first direction, between a first hold position at which the medium is held by the first roller pair and the support position.

5. The printing apparatus according to claim 4, wherein
the medium feeding section includes a third roller pair configured to transport the medium downstream along the transport path by rotating while holding the medium, and
a distance, in the direction perpendicular to both the width direction of the medium and the first direction, between a third hold position at which the medium is held by the third roller pair and the second hold position is larger than a distance, in the direction perpendicular to both the width direction of the medium and the first direction, between the first hold position and the second hold position.

6. The printing apparatus according to claim 1, wherein
the medium cutting section cuts the medium while moving in a width direction intersecting with the direction along which the medium is transported.
